(19) United States
(12) Patent Application Publication
(10) Pub. No.: US 2018/0003939 A1
(43) Pub. Date: Jan. 4, 2018

(54) APPARATUS FOR HOLDING A SUBSTRATE WITHIN A SECONDARY DEVICE

(71) Applicant: RareCyte, Inc., Seattle, WA (US)

(72) Inventors: Steve Quarre, Seattle, WA (US); David Stewart, Seattle, WA (US)

(73) Assignee: RareCyte, Inc., Seattle, WA (US)

(21) Appl. No.: 15/708,937

(22) Filed: Sep. 19, 2017

Related U.S. Application Data
(63) Continuation-in-part of application No. 14/718,381, filed on May 21, 2015.
(60) Provisional application No. 62/004,417, filed on May 29, 2014.

(51) Int. Cl. G02B 21/26; B01L 9/00

(52) U.S. Cl. CPC G02B 21/26; B01L 9/52; B01L 2200/023

(57) ABSTRACT

This disclosure is directed to an apparatus for securely holding a substrate, such as a microscope slide. A holder includes a frame including at least three walls, such as a base, a first arm, and a second arm. Each wall includes a platform or a portion of a platform to support the substrate. The first arm includes at least one securing block and a second arm opposite the first arm includes a secure bar with a securing block. The securing blocks include a ramp to guide the substrate off of the platforms and a stopper to set a maximum lift distance and to constrain the substrate.

### CROSS-REFERENCE TO A RELATED APPLICATIONS

This application is a continuation-in-part of application Ser. No. 14/718,381, filed May 21, 2015, which claims the benefit of Provisional Application No. 62/004,417, filed May 29, 2014.

### TECHNICAL FIELD

This disclosure relates generally to an apparatus for holding a substrate and, in particular, to an apparatus for securely holding a microscope slide on or within an imaging device.

### BACKGROUND

Analysis of a biological sample includes the step of imaging the biological sample on a substrate, such as a microscope slide. To image, the substrate may be placed on a stage and the stage may be moved relative to an objective. Alternatively, the objective may be moved relative to the stage. However, when the substrate is not consistently secured in a repeatable, predictable manner regardless of substrate inconsistencies or deformities, the images which may vary from substrate to substrate and may be difficult to determine proper surface locations.

As a result, practitioners, researchers, and those imaging samples on substrates continue to seek an apparatus for consistently, repeatably, and predictably securing substrates of varying inconsistencies or deformities. The apparatus, by not deforming the surface or imparting moments on the substrate due to the kinematic nature, may accommodate a wide variety of substrates based on size, shape, and configuration.

### DESCRIPTION OF THE DRAWINGS

FIGS. 1A-1C show an example holder.

FIGS. 2A-2B show an example secure bar.

FIG. 3 shows an example securing block.

FIGS. 4A-4B show an example holder.

### DETAILED DESCRIPTION

This disclosure is directed to an apparatus for securely holding a substrate, such as a microscope slide. A holder includes a frame including at least three walls, such as a base, a first arm, and a second arm. Each wall includes a platform or a portion of a platform to support the substrate. The first arm includes at least one securing block and a second arm opposite the first arm includes a secure bar with a securing block. The securing blocks include a ramp to guide the substrate off of the platforms and a stopper to set a maximum lift distance and to constrain the substrate. The secure bar may opened and closed, such that when in an open position, the secure bar permits the substrate to slide freely into and out the holder; and when in a closed position, the securing block on the secure bar and the at least one other securing block exert forces on the substrate to secure the substrate within the holder.

### Holder

For the sake of convenience, the holder 100 is described with reference to a U-shape frame as an example frame. But the frame described below is not intended to be so limited in its scope of application. The frame, in practice, may be a four-walled frame (i.e. a main body with a cavity extending through the main body), J-shaped, or the like.

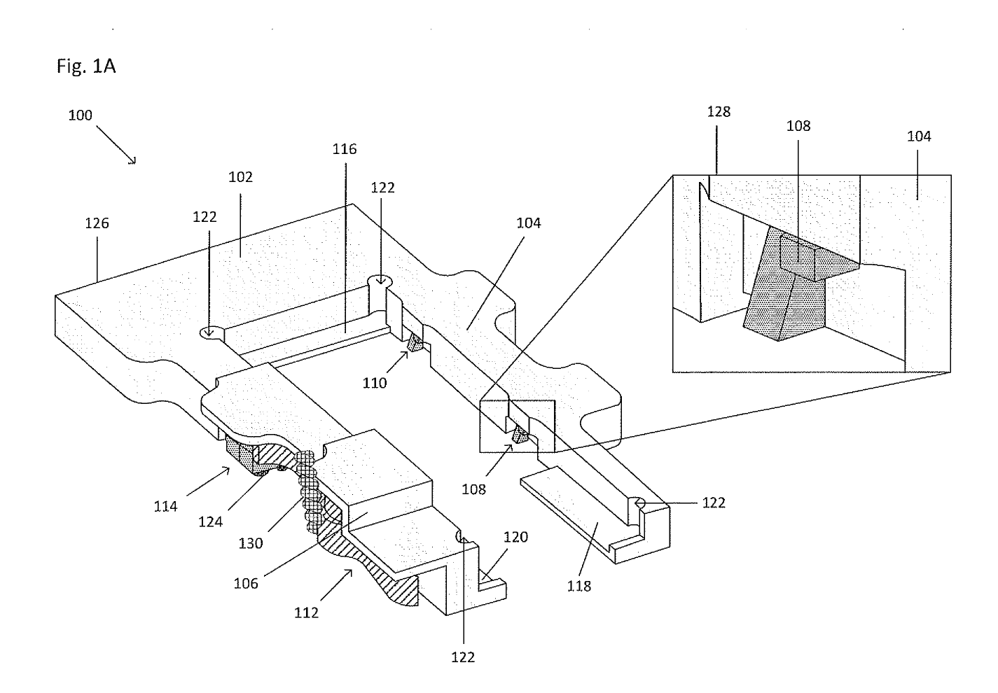

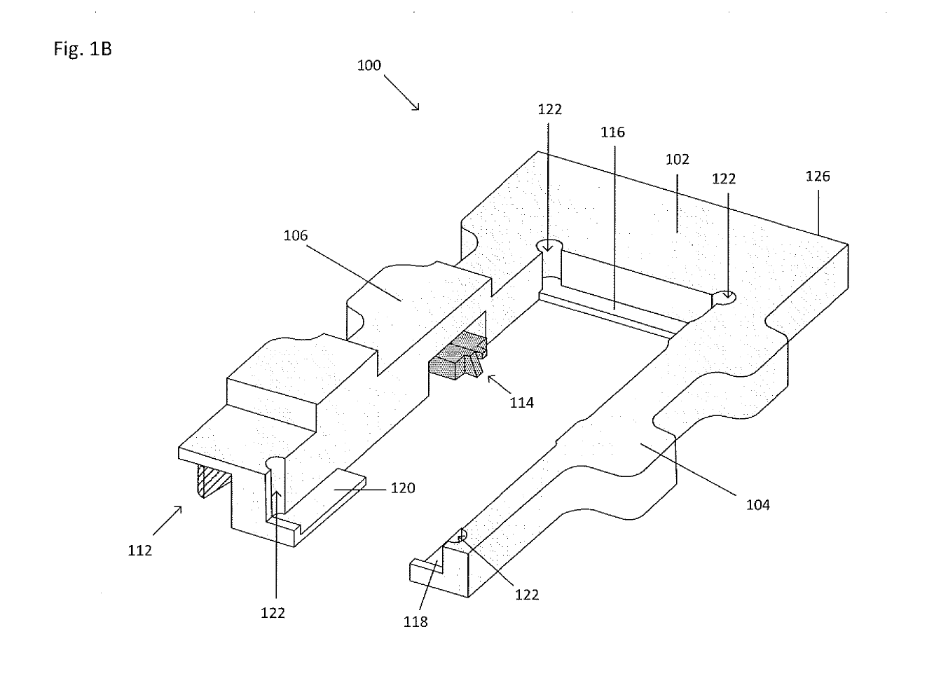

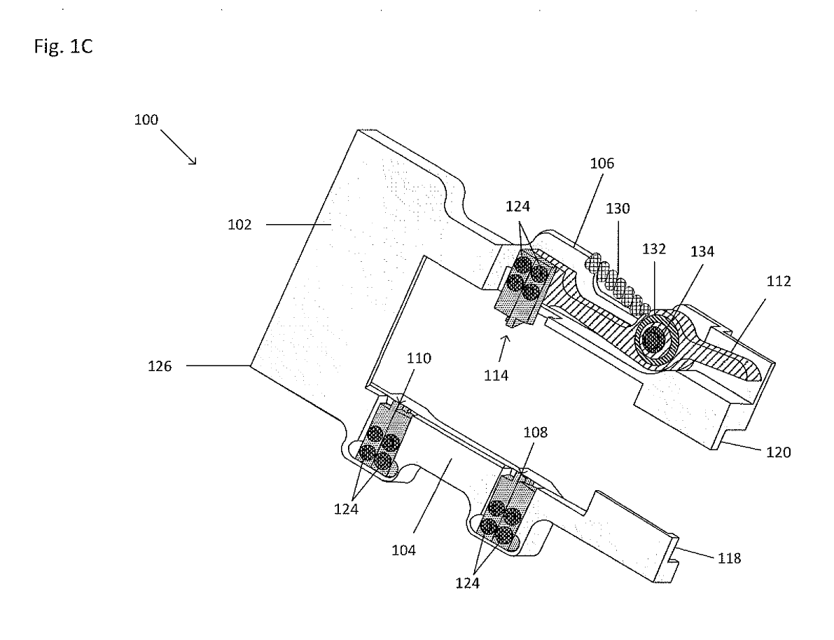

FIGS. 1A-1C shows isometric views of a holder 100 to securely hold a substrate, such as a microscope slide. The holder 100 includes a frame 126 including a base 102, a first arm 104, and a second arm 106. The first arm 104 includes a proximal end connected to a first end of the base 102 and a distal end extending from the base 102. The second arm 106 includes a proximal end connected to a second end of the base 102 and a distal end extending from the base 102. The base 102 includes a base platform 116 extending in the same direction as the first and second arms 104 and 106 to support a portion of the substrate. The first arm 104 may include a first platform 118 at the distal end and extending toward the second arm 106 to support a portion of the substrate. The second arm 106 may include a second platform 120 at the distal end and extending toward the first arm 104 to support a portion of the substrate. The first and second platforms 118 and 120 may be adjoined, thereby forming a single platform and connecting the first and second arms 104 and 106 at the distal ends of the first and second arms 118 and 120. The base platform 116, the first platform 118, and the second platform 120 may be located on the same plane. Alternatively, the first and second platforms 118 and 120 may be located at any point between the distal and proximal ends of the first and second arms 104 and 106, respectively.

The first arm 104 also includes first and second securing blocks 108 and 110 to provide first and second points of contact, respectively, for the substrate during imaging, processing, holding, or the like. The first and second securing blocks 108 and 110 guide the substrate off of the platforms and constrain the substrate at the first and second contact points, respectively. Snapshot 128 shows a magnified view of the first securing block 108. The first and second securing blocks 108 and 110 may be attached to the first arm 104 by at least one fastener 124 (i.e. a screw, a nail, a peg, a pin, a nut and bolt, a dowel, a staple, a rivet, or the like), by an adhesive, by welding, or the like. Alternatively, the first and second securing blocks 108 and 110 and the first arm 104 may be formed as a single piece, such as by molding, machining, or the like.

A third securing block 114 may be translatable towards and away from the substrate and the first arm 104. For example, the holder 100 also includes a secure bar 112 attached to the second arm 106 by a bearing 132 and a fastener 134. The third securing block 114, to provide a third point of contact for the substrate during imaging, processing, holding, or the like, may be attached to or may be formed as a part of the secure bar 112. The third securing block 114 guides the substrate off of the platforms and constrains the substrate at a third point. Furthermore, the three contact points imparted by the securing blocks 108, 110, and 114 provide for a kinematic mount. The bearing 132 allows the secure bar 112 to move relative to the second arm 106 into open and closed positions. When in the open position, the secure bar 112 permits the substrate to freely slide into and out the holder 100; and when in the closed position, the third securing block 114 on the secure bar 112 and the first and second securing blocks 108 and 110 exert forces on the substrate to secure the substrate within the holder 100. A spring 130 may also be included and may extend from the secure bar 112 to the second arm 106 to pre-load the secure bar 112. Alternatively, the third securing block 114 may be mounted on a track (not shown) adjoined to a spring (not shown) to move the third securing block 114 towards and away from the substrate (not shown) and the first arm 104.

The holder 100 may also include cutouts 122 on an inner corner where the proximal ends of the first and second arms 104 and 106 meet the base 102. There may also be cutouts 122 at the distal ends of the first and second arms 104 and 106. The cutouts 122 permit for any appropriately sized substrate to be used since the corners of the substrate may fit within the cutouts 122 instead of breaking off or chipping when being placed into the holder 100. The holder 100 may be composed of ceramic, glass, plastic, metal, or combinations thereof.

The holder 100 may be attached to a secondary device for imaging and/or processing by an attachment mechanism (i.e. a screw, a nail, a peg, a pin, a nut and bolt, a dowel, a staple, a rivet, or the like), by an adhesive, by welding, by clips, by detents, by tongue and groove joint, or the like. The holder 100 may include at least one hole to accommodate the attachment mechanism for proper, secure attachment to the secondary device.

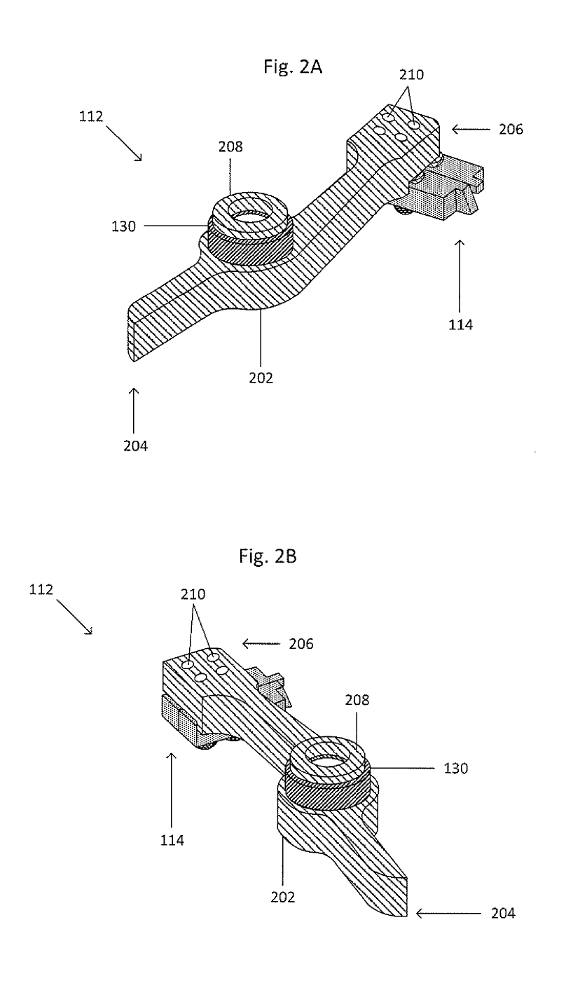

FIGS. 2A-2B show isometric views of the secure bar 112 with the third securing block 114 attached to the secure bar 112. The secure bar 112 includes a main body 202 having a first end 204 and a second end 206. The second end 206 may include at least one bore 210 extending at least partially through the second end 206 to accept the at least one fastener 124 to attach the third securing block 114 to the secure bar 112. The first end 204 includes a handle or grip to permit a force to be exerted on the main body 202 so as to move the secure bar 112 into the open and closed positions when it is desirous to do so. The secure bar 112 also includes the bearing 132 to move the main body 202 relative to the second arm (not shown) when exerting a force on the first end 204. Alternatively, the bearing 132 may be inserted into a cavity (not shown) in the second arm and the secure bar 112 may then be joined with the bearing 132 to allow for movement. The secure bar 112 may be moved into the open and closed positions when it is desirous to do so. The secure bar 112 may also include a Belleville spring 208 to pre-load to a bearing 128 and reduce movement of the bearing 128. The bearing 128 may be a single bearing or more than one bearing connected to allow for rotational movement.

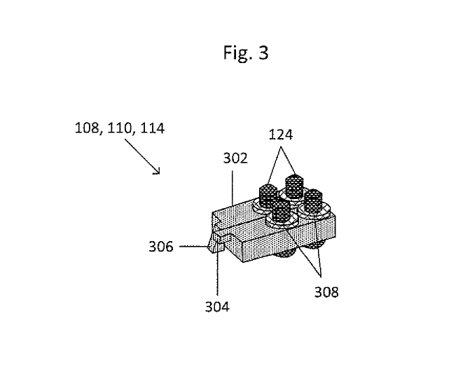

FIG. 3 shows an isometric view of the securing blocks 108, 110, and 114. The securing blocks 108, 110, and 114 provide a controlled references surface for the substrate during imaging, processing, holding, or the like. The securing blocks 108, 110, and 114 include a main body 302 with a stopper 304 and a ramp 306, both of which extend from the same side of the main body 302. When the secure bar (not shown) is moved into a closed position, the ramp 306 guides the substrate up and off of the platforms (not shown) and the stopper 304 sets a maximum lift distance and constrains the substrate. When the secure bar (not shown) is moved into an open position, the ramp 306 guides the substrate down and towards the platforms (not shown). The main body 302 may include at least one hole (not shown) to accept the at least one fastener 124 to attach to the second end of the secure bar (not shown). The main body 302 may be a single piece or may be two pieces. When the main body 302 is two pieces, a first piece includes the stopper 304 and a second piece includes the ramp 306. The securing blocks 108, 110, and 114 may also include at least one height adjuster 308, such as a shim, to adjust the heights of the securing blocks 108, 110, and 114 relative to the frame (not shown) of the holder (not shown).

The ramp 306 may be any appropriate shape, including, but not limited to, triangular, hemispherical, parabolic, trapezoidal, or the like.

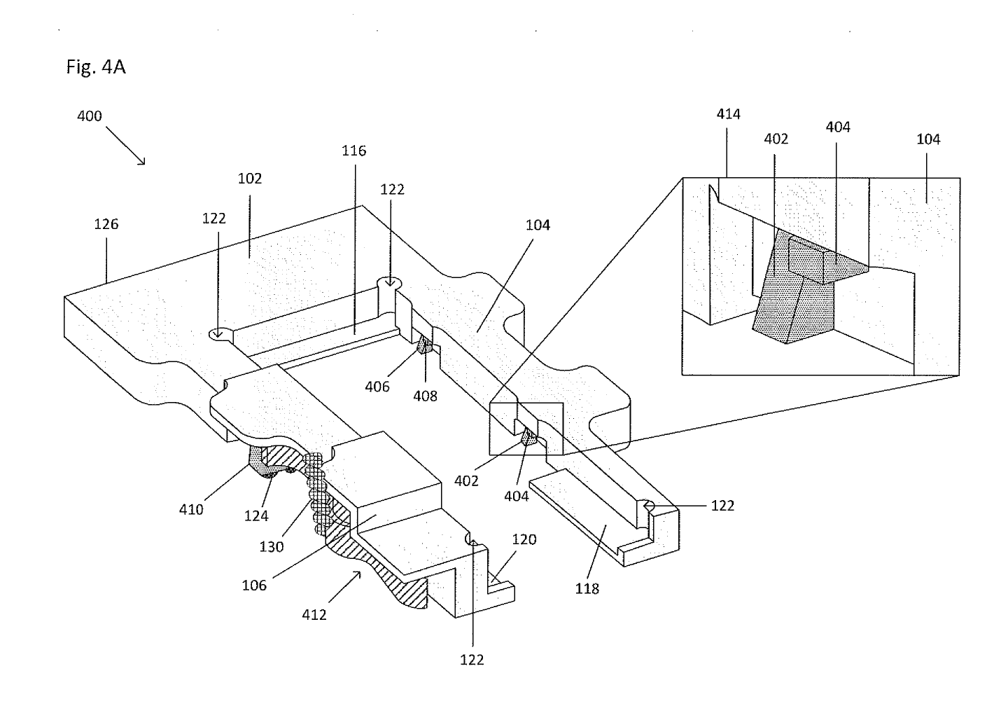

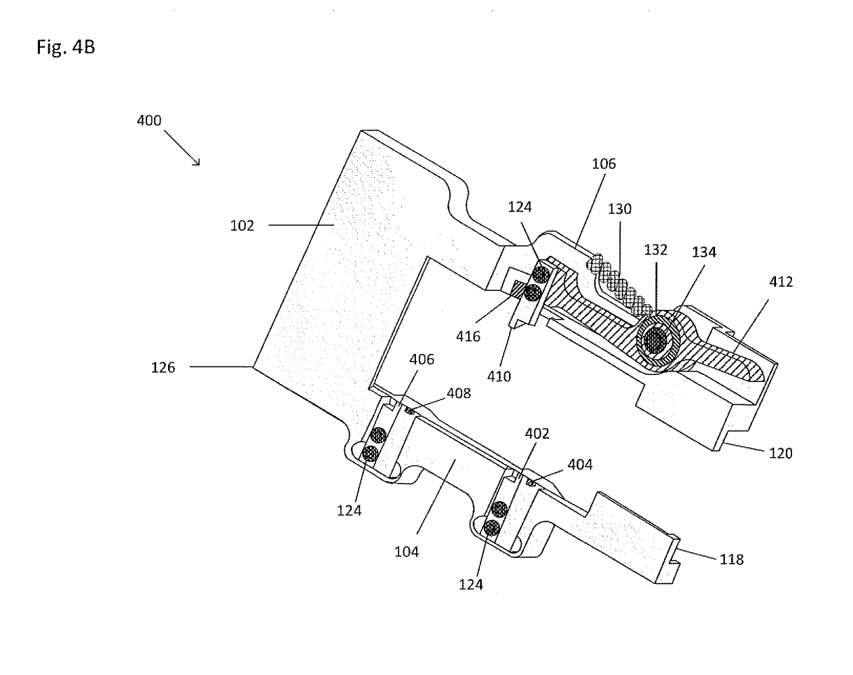

FIGS. 4A and 4B show isometric views of a holder 400. The holder 400 is similar to the holder 100 except that the components of the securing blocks 108, 110, 114 have been separated, such that a stopper 404, 408, 416 extends from the respective arm 104, 106 towards the substrate (not shown) and a ramp 402, 406, 410 extends from the respective arm 104, 106 or a secure bar 412 towards the substrate and the opposing arm 104, 106. Alternatively, the stopper 404, 408, 416 may extend from a plate which is attached to the underside of the holder 400.

Alternatively, the secure bar 112, 412 of the holder 100, 400 may be moved between the open and closed positions by a motor (not shown) which may be controlled by a controller or processor to automate the opening and closing of the secure 112, 412.

### Method

For the sake of convenience, the methods are described with reference to a slide as an example substrate. But the methods described below are not intended to be so limited in their scope of application. The methods, in practice, may be used with any kind of substrate including, but not limited to, a well plate.

First, the slide is inserted into the holder and placed onto the first, second, and base platforms with the secure bar in the open position. Second, the secure bar is moved into the closed position. The third securing block pushes the slide against the first and second securing blocks. The ramps of the respective securing blocks lift the slide up and off of the platforms. The stoppers of the respective securing blocks set the maximum lift distance for the slide and constrain the slide, thereby inhibiting any rotation. When the secure bar is set in the closed position, the force exerted on the slide by the securing blocks inhibits translational movement of the slide relative to the holder. Furthermore, the alignment and/or numbers of securing blocks may cause at least one slide surface to be planar and to be perpendicular relative to an objective of an imaging device. Once the slide is secured, the slide may be imaged. After imaging, the secure bar may be moved into the open position to release the forces on the slide. The ramps of the respective securing blocks guide the slide down and onto the first, second, and base platforms. The slide may then be removed from the holder and another slide inserted to restart the process.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

I/We claim:

1. A device comprising:
a base;
a first arm comprising at least one ramp and at least one stopper; and
a second arm comprising a ramp and a stopper, wherein the ramp of the second arm is translatable along at least a horizontal axis, and
wherein the first and second arms extend in the same direction from the base,
wherein the ramps are shaped to translate a substrate at least vertically, and
wherein the stoppers set the maximum translation distance for the substrate and constrains the substrate.

2. The device of claim 1, wherein the first arm comprises two ramps and two stoppers.

3. The device of claim 1, further comprising a secure bar on the second arm, wherein the ramp of the second arm is attached to the secure bar.

4. The device of claim 3, further comprising a spring extending from the secure bar to the second arm to pre-load the secure bar.

5. The device of claim 3, the secure bar further comprising:
an open position to insert the substrate or remove the substrate; and
a closed position to translate the substrate along a surface of the ramps and to constrain the substrate against the stoppers.

6. The device of claim 1, further comprising a track on the second arm, wherein the track is adjoined to a spring, and wherein the ramp of the second arm is adjoined to the track.

7. The device of claim 6, the track further comprising:
an open position to insert the substrate or remove the substrate; and
a closed position to translate the substrate along a surface of the ramps and to constrain the substrate against the stoppers.

8. The device of claim 1, further comprising at least one cutout on an inner corner where the first and second arms are connected to the base, the at least one cutout to accept a portion of the substrate.

9. The device of claim 1, wherein each of the ramps comprises at least one height adjuster to adjust the height of each ramp relative to the arm or secure bar to which the ramp is attached and at least one fastener for fastening the ramps to the second arm or the secure bar.

10. The device of claim 1, wherein the ramp is shaped to also translate the substrate horizontally.

11. The device of claim 1, the first arm comprising a platform extending towards the second arm.

12. A method comprising:
inserting a substrate into a holder, the holder comprising:
a base;
a first arm comprising at least one ramp and at least one stopper; and
a second arm comprising a ramp and a stopper, wherein the ramp of the second arm is translatable along at least a horizontal axis, and
wherein the first and second arms extend in the same direction from the base,
wherein the ramps are shaped to translate a substrate at least vertically, and
wherein the stoppers set the maximum translation distance for the substrate and constrains the substrate; and
translating the ramp of the second arm from an open position to a closed position, thereby causing the substrate to move at least vertically and constraining the substrate against the stopper.

13. The method of claim 12, wherein the first arm of the holder comprises two ramps and two stoppers.

14. The method of claim 12, the holder further comprising a secure bar on the second arm, wherein the ramp of the second arm is attached to the secure bar.

15. The method of claim 14, the holder further comprising a spring extending from the secure bar to the second arm to pre-load the secure bar.

16. The method of claim 1, the holder further comprising a track on the second arm, wherein the track is adjoined to a spring, and wherein the ramp of the second arm is adjoined to the track.

17. The method of claim 12, the holder further comprising at least one cutout on an inner corner where the first and second arms are connected to the base, the at least one cutout to accept a portion of the substrate.

18. The method of claim 12, wherein each of the ramps comprises at least one height adjuster to adjust the height of each ramp relative to the arm or secure bar to which the ramp is attached and at least one fastener for fastening the ramps to the second arm or the secure bar.

19. The method of claim 12, wherein the at least one ramp on the first arm is shaped to also translate the substrate horizontally.

20. The method of claim 12, wherein the open position permits the substrate to be inserted or removed from the holder.
